(19) United States
(12) Patent Application Publication
(10) Pub. No.: US 2019/0296980 A1
(43) Pub. Date: Sep. 26, 2019

(54) Storage Medium Storing Communication Program, Communication Method, and Communication System

(71) Applicant: Brother Kogyo Kabushiki Kaisha, Nagoya-shi (JP)

(72) Inventors: Kentaro Arai, Nagoya-shi (JP); Yasuhiro Kudo, Ichinomiya-shi (JP)

(21) Appl. No.: 16/261,715

(22) Filed: Jan. 30, 2019

(30) Foreign Application Priority Data
Mar. 20, 2018 (JP) 2018-052009

(51) Int. Cl. H04L 12/24; H04L 29/06; H04L 29/08; H04L 1/16

(52) U.S. Cl. CPC H04L 41/12; H04L 67/42; H04L 67/1097; H04L 1/1607; H04L 67/141; H04L 67/148; H04L 67/143

(57) ABSTRACT

A first server apparatus performs: transmitting, to a first terminal apparatus, a connection request for requesting connection between the first terminal apparatus and a second server apparatus; after connection, receiving a connection completion notification transmitted from the first terminal apparatus; in response to receiving the connection completion notification, transmitting a first update request to the second server apparatus; after the second management table is updated, receiving a first update completion notification transmitted from the second server apparatus; in response to receiving the first update completion notification, transmitting a second update request to a third server apparatus; after the third management table is updated, receiving a second update completion notification from the third server apparatus; and in response to receiving the second update completion notification, updating the handling server apparatus of the first terminal apparatus specified in a first management table from the first server apparatus to the second server apparatus.

### CROSS REFERENCE TO RELATED APPLICATIONS

This application claims priority from Japanese Patent Application No. 2018-052009 filed Mar. 20, 2018. The entire content of the priority application is incorporated herein by reference.

### TECHNICAL FIELD

This disclosure relates to a storage medium storing a communication program, a communication method, and a communication system.

### BACKGROUND

Various communication methods have been suggested to perform a teleconference between a server apparatus and a terminal apparatus connected through a network. A multipoint conference system is suggested. The multipoint conference system includes a plurality of MCUs, a resource management server, and a plurality of terminals. The respective MCUs and the plurality of terminals are connected to networks for the respective areas (hereinafter referred to as “area network”). The respective MCUs control a multipoint conference (hereinafter simply referred to as “conference”) by transferring packets transmitted and received among the plurality of terminals. The resource management server performs resource management on each of the plurality of MCUs. For example, when a first MCU controlling a specific conference has insufficient resources, request information is transmitted to the resource management server. Based on the request information, the resource management server extracts a second MCU as a substitute and notifies the second MCU. The second MCU transmits the address of the second MCU to a plurality of terminals participating in the conference controlled by the first MCU and switches a connection destination to continue the conference.

### SUMMARY

According to one aspect, this specification discloses a non-transitory computer-readable storage medium storing a communication program executable on a computer of a first server apparatus in a plurality of server apparatuses configured to control communication among a plurality of terminal apparatuses. Each of the plurality of server apparatuses has a memory storing a management table specifying a handling server apparatus configured to perform communication with the plurality of terminal apparatuses. Each of the plurality of server apparatuses is configured to identify a terminal apparatus to perform communication with based on the management table and to transfer data to the identified terminal apparatus. The communication program causes, when executed, the first server apparatus to perform operations including: transmitting, to a first terminal apparatus, a connection request for requesting connection between the first terminal apparatus and a second server apparatus different from the first server apparatus; after the first terminal apparatus and the second server apparatus are connected based on the connection request, receiving a connection completion notification transmitted from the first terminal apparatus; in response to receiving the connection completion notification, transmitting a first update request to the second server apparatus, the first update request being for updating the handling server apparatus of the first terminal apparatus specified in a second management table from the first server apparatus to the second server apparatus, the second management table being stored in a second memory of the second server apparatus; after the second management table is updated based on the first update request, receiving a first update completion notification transmitted from the second server apparatus; in response to receiving the first update completion notification, transmitting a second update request to a third server apparatus, the second update request being for updating the handling server apparatus of the first terminal apparatus specified in a third management table from the first server apparatus to the second server apparatus, the third management table being stored in a third memory of a third server apparatus different from the first server apparatus and the second server apparatus; after the third management table is updated based on the second update request, receiving a second update completion notification transmitted from the third server apparatus; and in response to receiving the second update completion notification, updating the handling server apparatus of the first terminal apparatus specified in a first management table from the first server apparatus to the second server apparatus, the first management table being stored in a first memory of the first server apparatus, thereby changing the handling server apparatus of the first terminal apparatus from the first server apparatus to the second server apparatus.

According to another aspect, this specification also discloses a communication method performed by a plurality of server apparatuses configured to control communication among a plurality of terminal apparatuses. Each of the plurality of server apparatuses has a memory storing a management table specifying a handling server apparatus configured to perform communication with the plurality of terminal apparatuses. Each of the plurality of server apparatuses is configured to identify a terminal apparatus to perform communication with based on the management table and to transfer data to the identified terminal apparatus. The method including: transmitting, from a first server apparatus to a first terminal apparatus, a connection request for requesting connection between the first terminal apparatus and a second server apparatus different from the first server apparatus; after the first terminal apparatus and the second server apparatus are connected based on the connection request, receiving, by the first server apparatus, a connection completion notification transmitted from the first terminal apparatus; in response to receiving the connection completion notification, transmitting a first update request from the first server apparatus to the second server apparatus, the first update request being for updating the handling server apparatus of the first terminal apparatus specified in a second management table from the first server apparatus to the second server apparatus, the second management table being stored in a second memory of the second server apparatus; after the second management table is updated based on the first update request, receiving, by the first server apparatus, a first update completion notification transmitted from the second server apparatus; in response to receiving the first update completion notification, transmitting a second update request from the first server apparatus to a third server apparatus, the second update request being for updating the handling server apparatus of the first terminal apparatus specified in a third management table from the first server apparatus to the second server apparatus, the third management table being stored in a third memory of a third server apparatus different from the first server apparatus and the second server apparatus; after the third management table is updated based on the second update request, receiving, by the first server apparatus, a second update completion notification transmitted from the third server apparatus; and in response to receiving the second update completion notification, updating the handling server apparatus of the first terminal apparatus specified in a first management table from the first server apparatus to the second server apparatus, the first management table being stored in a first memory of the first server apparatus, thereby changing the handling server apparatus of the first terminal apparatus from the first server apparatus to the second server apparatus.

According to still another aspect, this specification also discloses a communication system. The communication system includes a plurality of terminal apparatuses and a plurality of server apparatuses. The plurality of server apparatuses is configured to control communication among the plurality of terminal apparatuses. Each of the plurality of server apparatuses has a memory storing a management table specifying a handling server apparatus configured to perform communication with the plurality of terminal apparatuses. Each of the plurality of server apparatuses is configured to identify a terminal apparatus to perform communication with based on the management table and to transfer data to the identified terminal apparatus. A first server apparatus of the plurality of server apparatuses includes: a controller; and a first memory storing instructions, the instructions, when executed by the controller, causing the first server apparatus to perform: transmitting, to a first terminal apparatus, a connection request for requesting connection between the first terminal apparatus and a second server apparatus different from the first server apparatus; after the first terminal apparatus and the second server apparatus are connected based on the connection request, receiving a connection completion notification transmitted from the first terminal apparatus; in response to receiving the connection completion notification, transmitting a first update request to the second server apparatus, the first update request being for updating the handling server apparatus of the first terminal apparatus specified in a second management table from the first server apparatus to the second server apparatus, the second management table being stored in a second memory of the second server apparatus; after the second management table is updated based on the first update request, receiving a first update completion notification transmitted from the second server apparatus; in response to receiving the first update completion notification, transmitting a second update request to a third server apparatus, the second update request being for updating the handling server apparatus of the first terminal apparatus specified in a third management table from the first server apparatus to the second server apparatus, the third management table being stored in a third memory of a third server apparatus different from the first server apparatus and the second server apparatus; after the third management table is updated based on the second update request, receiving a second update completion notification transmitted from the third server apparatus; and in response to receiving the second update completion notification, updating the handling server apparatus of the first terminal apparatus specified in a first management table from the first server apparatus to the second server apparatus, the first management table being stored in the first memory of the first server apparatus, thereby changing the handling server apparatus of the first terminal apparatus from the first server apparatus to the second server apparatus. The first terminal apparatus includes: a terminal controller; and a terminal memory storing instructions, the instructions, when executed by the controller, causing the first terminal apparatus to perform: in response to receiving the connection request transmitted from the first server apparatus, connecting with the second server apparatus; and after connecting with the second server apparatus, transmitting the connection completion notification to the first server apparatus.

### BRIEF DESCRIPTION OF THE DRAWINGS

Embodiments in accordance with this disclosure will be described in detail with reference to the following figures wherein:

FIG. 1 is a diagram illustrating an outline of a communication system 1 and electrical configurations of a server apparatus S and a terminal apparatus C;

FIG. 2 is a diagram illustrating setting information 16;

FIG. 3 is a diagram illustrating a communication sequence in a first phase;

FIG. 4 is a diagram illustrating a communication sequence in a second phase;

FIG. 5 is a diagram illustrating a communication sequence in a third phase;

FIG. 6 is a diagram illustrating a communication sequence in a fourth phase; and

FIG. 7 is a diagram illustrating setting information 16A to 16C.

### DETAILED DESCRIPTION

In order to allow the conference to proceed, a plurality of packets transmitted from a transmission-side terminal are preferably received by a reception-side terminal in a sequence of the transmission. However, when the MCU controlling the conference is switched by the above method, packets are transferred by a plurality of MCUs at a switching stage, which may prevent the reception-side terminal from receiving the plurality of packets in the sequence of the transmission. Furthermore, in the case of the above multipoint conference system, the MCU must transmit a query to the resource management server in order to switch the conference controlled by the MCU to another MCU, which may result in complicated processing.

An example of an object of this disclosure is to provide a storage medium storing a communication program, a communication method, and a communication system by which processing is easily performed to switch a server apparatus controlling a conference to another server apparatus and a plurality of packets is received by a reception-side terminal during switching in a sequence of the transmission.

<Outline of the Communication System 1>

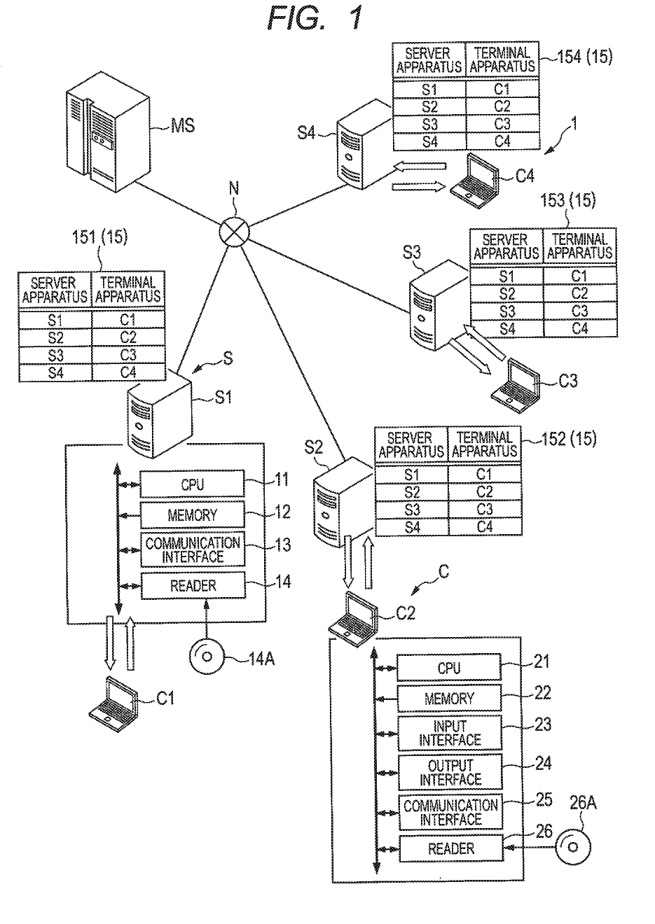

With reference to FIG. 1, the following section will describe a communication system 1. The communication system 1 includes server apparatuses S1, S2, S3, and S4 for example (hereinafter collectively referred to as “server apparatus S”), terminal apparatuses C1, C2, C3, and C4 for example (hereinafter collectively referred to as “terminal apparatus C”), and a master server apparatus MS. The server apparatus S, the terminal apparatus C, and the master server apparatus MS are mutually connected through a network N (LAN, the Internet, and so on). The terminal apparatus C is configured by installing a teleconference application program in a well-known personal computer (PC). The server apparatus S is configured by a Multipoint Control Unit (MCU) or by installing a dedicated application program in a well-known server.

The terminal apparatus C conducts a teleconference by performing communication with another terminal apparatus C through the server apparatus S. When a teleconference is held, in the communication system 1, a server apparatus S is allocated to each of the terminal apparatuses C participating in the teleconference (hereinafter referred to as “handling server apparatus”). Video data and audio data (hereinafter referred to as “conference data”) for the teleconference are transferred through the handling server apparatus allocated to the terminal apparatus C. In this case, the terminal apparatus C and the handling server apparatus allocated to the terminal apparatus C have therebetween no server apparatus S other than the handling server apparatus. The video data is data regarding video taken by a camera of the terminal apparatus C for example. The audio data is data regarding audio collected by a microphone of the terminal apparatus C for example.

For example, FIG. 1 illustrates a state in which the server apparatus S1 is allocated as a handling server apparatus that handles the terminal apparatus C1 (hereinafter may also be referred to as “the handling server apparatus of the terminal apparatus C”), the server apparatus S2 is allocated as the handling server apparatus of the terminal apparatus C2, the server apparatus S3 is allocated as the handling server apparatus of the terminal apparatus C3, and the server apparatus S4 is allocated as the handling server apparatus of the terminal apparatus C4. For example, conference data addressed to the terminal apparatus C1, which is transmitted from the terminal apparatuses C2, C3, and C4, is transferred to the server apparatus S1 through the server apparatuses S2, S3, and S4. When the server apparatus S1 receives, from the server apparatuses S2, S3, and S4, the conference data addressed to the terminal apparatus C1, the server apparatus S1 transmits this conference data to the terminal apparatus C1 without passing through the server apparatuses S2 to S4. When the terminal apparatus C1 has the conference data addressed to the terminal apparatuses C2, C3, to C4 for example, the terminal apparatus C1 transmits this conference data to the server apparatus S1 without passing through the server apparatuses S2 to S4. The server apparatus S1 transfers, to the server apparatuses S2, S3, and S4, the conference data addressed to the terminal apparatuses C2, C3, to C4 received from the terminal apparatus C1. The server apparatuses S2, S3, and S4 transfer the conference data to the terminal apparatuses C2, C3, and C4 handled by the server apparatuses S2, S3, and S4, respectively. In FIG. 1, each server apparatus S handles one terminal apparatus C but also may handle two or more terminal apparatuses C.

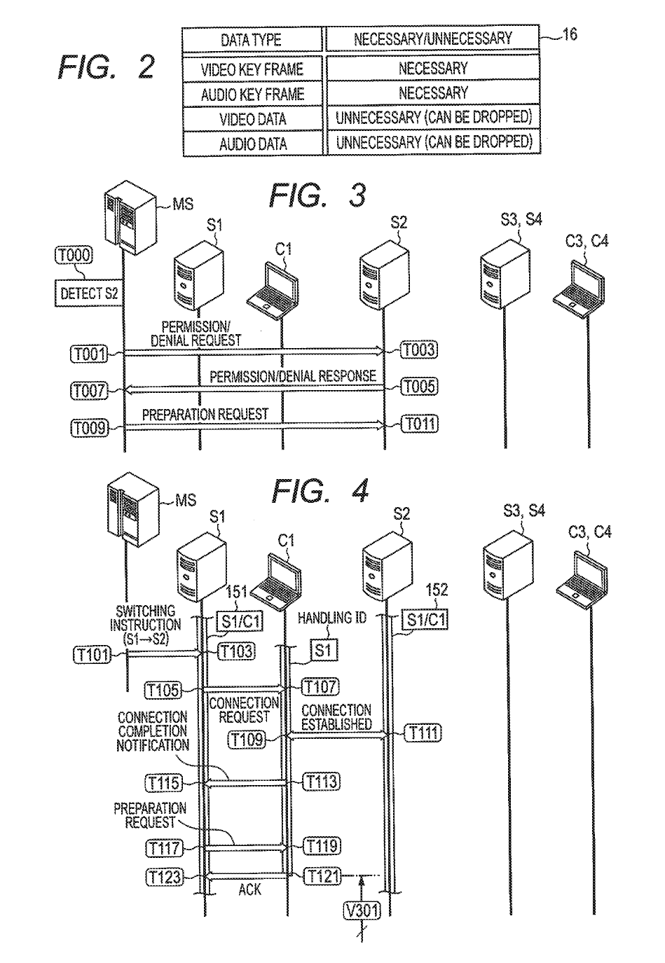

When the server apparatus S receives the conference data from the terminal apparatus C and transfers the data or when the server apparatus S receives the conference data from another server apparatus S and transfers the data to the terminal apparatus C, the server apparatus S transfers at least part of a video key frame, an audio key frame, video data, and audio data (hereinafter referred to as “particular data”) specified based on setting information 16 described later (see FIG. 2). For example, when audio data is specified as particular data based on the setting information 16 for the terminal apparatus C, the server apparatus S transfers only the audio data to the terminal apparatus C even when the server apparatus S receives video data and audio data from the terminal apparatus C and other server apparatuses S. The setting information 16 is stored in a memory 12 (described later) of each server apparatus S. The setting information 16 is specified for each terminal apparatus C participating in the teleconference. When the server apparatus S receives setting change data from the master server apparatus MS or the terminal apparatus C, the server apparatus S changes the setting information 16 based on the setting change data.

<Electrical Configuration>

The terminal apparatus C has a CPU 21, a memory 22, an input interface 23, an output interface 24, a communication interface 25, and a reader 26. The CPU 21 is responsible for the entirety of the control by the terminal apparatus C. The memory 22 stores various programs executed by the CPU 21. The memory 22 stores therein the ID of the handling server apparatus (which will be referred to as a “handling server ID”). The memory 22 includes a plurality of transmission buffers and a plurality of reception buffers to store conference data in a FIFO format. For example, when the CPU 21 transmits the conference data to another terminal apparatus C, the CPU 21 stores the conference data sequentially in each of the plurality of transmission buffers. Then, the CPU 21 extracts the conference data stored in each of the plurality of transmission buffers in a sequence in which the data is stored in the plurality of transmission buffers, and transmits the data. When the CPU 21 receives the conference data transmitted from the server apparatus S, the CPU 21 sequentially stores the conference data in a plurality of reception buffers. Then, the CPU 21 extracts and processes the conference data stored in the plurality of reception buffers in a sequence in which the data is stored in the plurality of reception buffers.

The input interface 23 includes a camera, a microphone, a keyboard, and a mouse for example. The output interface 24 includes an LCD and a speaker for example. The communication interface 25 is an interface element to provide communication through the network N. The reader 26 reads information stored in a storage medium 26A such as a semiconductor memory or an optical disc. The CPU 21 controls the reader 26 to read a program stored in the storage medium 26A and stores the program in the memory 22. The program stored in the memory 22 may also be downloaded from another server connected to the network N for example.

The server apparatus S has a CPU 11, a memory 12, a communication interface 13, and a reader 14. The CPU 11 is responsible for the entirety of the control by the server apparatus S. The memory 12 stores therein various programs executed by the CPU 11, a management table 15 described later, and the setting information 16. The memory 12 includes a plurality of transfer buffers to store conference data in a FIFO (First In, First Out) format. The FIFO format is also called as a First In, First Out format according to which data is extracted from an array in a sequence in which the data are stored in the array. For example, when the CPU 11 receives conference data transmitted from another server apparatus S or terminal apparatus C, the CPU 11 sequentially stores the conference data in a plurality of transfer buffers. Then, the CPU 11 extracts the conference data stored in each of the plurality of transfer buffers in a sequence in which the data are stored in the plurality of transfer buffers and transmits the data to transfer the data to other server apparatus S or terminal apparatus C.

The communication interface 13 is an interface element to provide communication through the network N. The reader 14 reads information stored in a storage medium 14A such as a semiconductor memory or an optical disc. The CPU 11 controls the reader 14 to read a program stored in the storage medium 14A and stores the data in the memory 12. The program stored in the memory 12 may also be downloaded from another server connected to the network N, for example.

<Management Table 15>

The management table 15 is stored in the memory 12 of each server apparatus S. The management table 15 specifies a handling server apparatus for each terminal apparatus C. The IDs of the terminal apparatuses C and the handling server apparatuses are associated and stored in the management table 15. In the state shown in FIG. 1, the IDs of the server apparatus S1 and the terminal apparatus C1, the IDs of the server apparatus S2 and the terminal apparatus C2, the IDs of the server apparatus S3 and the terminal apparatus C3, and the IDs of the server apparatus S4 and the terminal apparatus C4 are respectively associated with each other and stored in the management table 15.

The CPU 11 of the server apparatus S refers to the management table 15 stored in the memory 12, and identifies the terminal apparatus C that the server apparatus S itself handles. When the CPU 11 receives, from another server apparatus S, conference data addressed to the identified terminal apparatus C, the CPU 11 transfers the received conference data to the terminal apparatus C without passing through other server apparatuses S. When the CPU 11 receives, from the terminal apparatus C that the CPU 11 handles, the conference data addressed to another terminal apparatus C, the CPU 11 refers to the management table 15 stored in the memory 12 to identify another server apparatus S that handles the another terminal apparatus C. The CPU 11 transfers the received conference data to the identified server apparatus S.

In the following description, it is assumed that the CPUs 21 of the terminal apparatuses C1, C2, C3, and C4 are referred to as “CPU 211”, “CPU 212”, “CPU 213”, and “CPU 214”, respectively. It is assumed that the CPUs 11 of the server apparatuses S1, S2, S3, and S4 are referred to as “CPU 111”, “CPU 112”, “CPU 113”, and “CPU 114”, respectively. It is assumed that the memories 12 of the server apparatuses S1, S2, S3, and S4 are referred to as “memory 121”, “memory 122”, “memory 123”, and “memory 124”, respectively. It is assumed that the management tables 15 stored in the respective memories 121, 122, 123, and 124 are referred to as “management table 151”, “management table 152”, “management table 153”, and “management table 154”, respectively.

<Setting Information 16>

The setting information 16 is stored in the memory 12 of each server apparatus S. FIG. 2 illustrates one example of the setting information 16. The setting information 16 includes therein data types “video key frame”, “audio key frame”, “video data”, and “audio data” respectively associated with information showing whether the data type is necessary. The video key frame and the audio key frame correspond to data of a frame functioning as a starting point of the video and audio, respectively. The video data and the audio data correspond to data showing a difference from the key frame. Based on the setting information 16 shown in FIG. 2, particular data (video key frame, audio key frame) is specified as conference data transferred from the server apparatus S. Specifically, the particular data is data associated with information showing that the data is necessary. When the CPU 11 of the server apparatus S receives the conference data from another server apparatus S or terminal apparatus C, the CPU 11 transfers only the particular data specified by the setting information 16 and does not transfer other data.

The setting information 16 is associated with flag information. The flag information shows whether the setting information 16 is changed in response to setting change data transmitted from the master server apparatus MS or the terminal apparatus C. The setting information 16 prior to the change is associated with flag information “0” showing that the setting information 16 is not changed. When the setting information 16 is changed in response to the setting change data, the setting information 16 is associated with flag information “1” showing that the setting information 16 is changed.

<Communication Sequence>

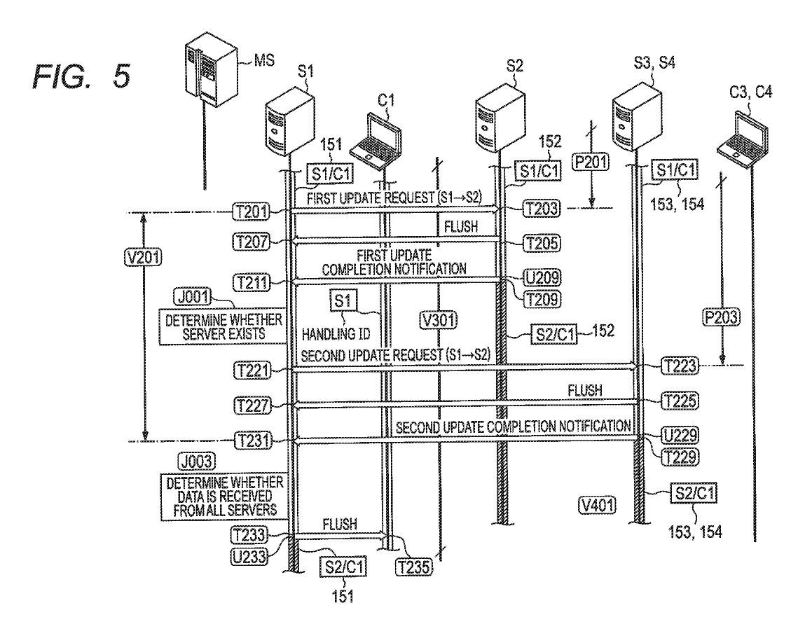

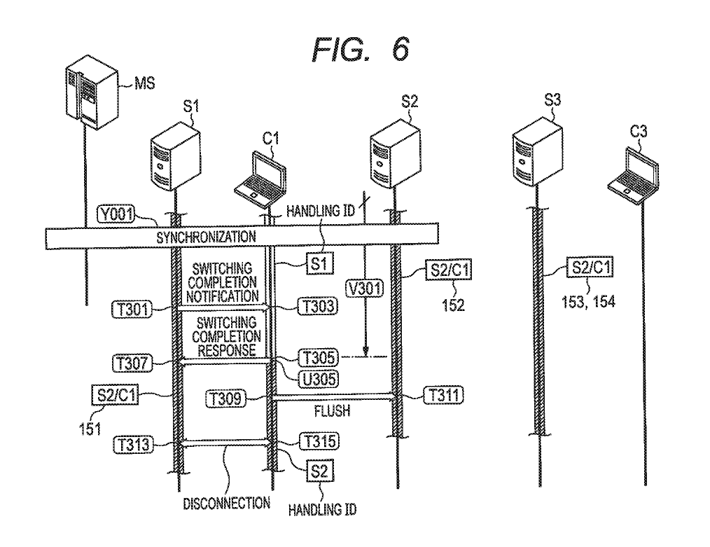

The following section will describe a communication sequence used when the handling server apparatus of the terminal apparatus C1 is switched from the server apparatus S1 to the server apparatus S2. As shown in FIG. 1, it is assumed that the respective server apparatuses S handle the terminal apparatuses C and that the memories 121 to 124 of the server apparatuses S1 to S4 store therein the management tables 151 to 154, respectively. FIGS. 3 to 6 illustrate the communication sequences in respective phases (a first phase to a fourth phase). In the first phase shown in FIG. 3, the master server apparatus MS checks with the server apparatus S2 whether to permit that the server apparatus S2 newly handles the terminal apparatus C1. In the second phase shown in FIG. 4, a link connection is established between the terminal apparatus C1 and the server apparatus S2. In the third phase shown in FIG. 5, the respective management tables 151 to 154 of the server apparatuses S1 to S4 are updated to thereby switch the handling server apparatus of the terminal apparatus C1 from the server apparatus S1 to the server apparatus S2. In the fourth phase shown in FIG. 6, after the synchronization processing of the setting information 16, the link connection between the terminal apparatus C1 and the server apparatus S1 is disconnected. The first phase, the second phase, the third phase, and the fourth phase are performed in this sequence.

The CPU 11 of the server apparatus S reads and executes a program stored in the memory 12 to thereby execute processing corresponding to the communication sequence. The CPU 11 executes transfer processing shown below in parallel with the processing based on the following communication sequence. When the CPU 11 receives conference data, the CPU 11 sequentially stores the received conference data in a plurality of transfer buffers of the memory 12. It is assumed in the following description that the CPU 11 sequentially extracts the conference data stored in the plurality of transfer buffers in a FIFO format unless otherwise specified. The CPU 11 specifies a transmission destination for the extracted conference data (another server apparatus S or terminal apparatus C) based on the management table 15 stored in the memory 12. Furthermore, the CPU 11 extracts, from the extracted conference data, the particular data specified by the setting information 16 stored in the memory 12. Based on the specified transmission destination, the CPU 11 transmits the extracted particular data.

The CPU 21 of the terminal apparatus C reads and executes the program stored in the memory 22 to thereby execute processing corresponding to the communication sequence. The CPU 21 executes, in parallel with the processing based on the following communication sequence, a transmission processing and a reception processing shown below. In the transmission processing, when the CPU 21 acquires the conference data through a camera and a microphone of the input interface 23, the acquired conference data is stored in a plurality of transmission buffers of the memory 22. The CPU 21 sequentially extracts the conference data stored in the plurality of transmission buffers in a FIFO format, unless otherwise specified below. Furthermore, the CPU 21 specifies a handling server apparatus based on the handling server ID stored in the memory 22. The CPU 21 transmits, to the specified handling server apparatus, the conference data sequentially extracted from the plurality of transmission buffers. In the reception processing, the CPU 21 receives the particular data transmitted from the handling server apparatus and sequentially stores the data in a plurality of reception buffers. The CPU 21 extracts and processes the particular data stored in each of the plurality of reception buffers in a sequence in which the data are stored in the plurality of reception buffers. Specifically, the CPU 21 controls the LCD of the output interface 24 to display a video image based on the extracted video data. The CPU 21 controls a speaker of the output interface 24 to output audio based on the extracted audio data.

<First Phase>

With reference to FIG. 3, the following section will describe the communication sequence in the first phase. For example, the CPU of the master server apparatus MS detects an increase of the processing load on the CPU 11 of the server apparatus S1. The CPU of the master server apparatus MS detects the server apparatus S2 as a new server apparatus that handles the terminal apparatus C1 and that replaces the server apparatus S1 (T000). The CPU of the master server apparatus MS transmits, to the server apparatus S2, permission/denial request data to query whether to permit that the server apparatus S2 newly handles the terminal apparatus C1 (T001). The CPU 112 of the server apparatus S2 receives the permission/denial request data (T003). The CPU 112 determines whether to permit that the server apparatus S2 newly handles the terminal apparatus C1 and transmits, to the master server apparatus MS, permission/denial response data (permission response data or denial response data) including the determination result (T005). The CPU of the master server apparatus MS receives the permission/denial response data (T007). When the data is the permission response data to permit that the server apparatus S2 newly handles the terminal apparatus C1, the CPU of the master server apparatus MS transmits, to the server apparatus S2, preparation request data requesting that the server apparatus S2 prepares to handle the terminal apparatus C1 (T009). The CPU 112 of the server apparatus S2 receives the preparation request data (T011).

<Second Phase>

With reference to FIG. 4, the following section will describe the communication sequence in the second phase. The CPU of the master server apparatus MS transmits, to the server apparatus S1, switching instruction data to switch the handling server apparatus of the terminal apparatus C1 from the server apparatus S1 to the server apparatus S2 (T101). The CPU 111 of the server apparatus S1 receives the switching instruction data (T103). The CPU 111 transmits, to the terminal apparatus C1, connection request data requesting a link connection between the terminal apparatus C1 and the server apparatus S2 (T105). The CPU 211 of the terminal apparatus C1 receives the connection request data (T107). Then, the terminal apparatus C1 and the server apparatus S2 have therebetween particular communication to establish the link connection, thereby establishing the link connection between the terminal apparatus C1 and the server apparatus S2 (T109, T111). After the link connection with the server apparatus S2 is established, the CPU 211 of the terminal apparatus C1 transmits, to the server apparatus S1, connection completion notification data notifying that the establishment of the link connection is completed (T113). The CPU 111 of the server apparatus S1 receives the connection completion notification data (T115).

The CPU 111 of the server apparatus S1 transmits, to the terminal apparatus C1, preparation request data requesting preparation for switching the handling server apparatus of the terminal apparatus C1 from the server apparatus S1 to the server apparatus S2 (T117). The CPU 211 of the terminal apparatus C1 receives the preparation request data (T119). The CPU 211 transmits, to the server apparatus S1, an ACK (acknowledgement response, or Acknowledgement) notifying that the preparation request data is received (T121). The CPU 111 of the server apparatus S1 receives the ACK (T123).

After the transmission of the ACK (T121) is completed, the CPU 211 of the terminal apparatus C1 suspends transmission processing and reception processing executed in parallel with the communication sequence until switching completion response data is transmitted in T305 described later (see FIG. 6). More specifically, when the CPU 211 acquires conference data through a camera and a microphone of an input interface 53 during the period from T121 to T305, the CPU 211 stores the acquired conference data in a plurality of transmission buffers of the memory 22 (V301, see FIG. 3 to FIG. 5). On the other hand, the CPU 211 does not sequentially extract the conference data stored in the plurality of transmission buffers and does not transmit the conference data to the server apparatus S1 based on the handling server ID “S1”. When the CPU 211 receives particular data from the server apparatus S, the CPU 211 sequentially stores the received particular data in a plurality of reception buffers. On the other hand, the CPU 211 does not sequentially extract the particular data stored in the plurality of reception buffers and does not process the data (V301).

At the time of the completion of the second phase, each of the management table 151 of the server apparatus S1 and the management table 152 of the server apparatus S2 are not updated and are maintained in the state shown in FIG. 1, respectively. Thus, the management tables 151 and 152 include therein the ID “S1” of the server apparatus S1, associated with the ID “C1” of the terminal apparatus C1. The handling server ID of the terminal apparatus C1 is not changed and is maintained in the state “S1”.

<Third Phase>

With reference to FIG. 5, the following section will describe the communication sequence in the third phase. The CPU 111 of the server apparatus S1 transmits a first update request data to the server apparatus S2, in order to change the handling server apparatus of the terminal apparatus C1 specified in the management table 152 (see FIG. 1) stored in the memory 122 of the server apparatus S2 from the server apparatus S1 to the server apparatus S2 (T201). After completing the transmission of the first update request data (T201), the CPU 111 suspends the transfer processing executed in parallel with the communication sequence until a second update completion notification data is received in T231 described later. More specifically, when the CPU 111 receives the conference data addressed to the terminal apparatus C1 during the period from T201 to T231, the CPU 111 stores the conference data in a plurality of transfer buffers provided in the memory 121 (V201). On the other hand, the CPU 111 does not sequentially extract the conference data stored in the plurality of transfer buffers and does not transmit the data to the terminal apparatus C1 (V201).

The CPU 112 of the server apparatus S2 receives the first update request data (T203). The CPU 112 performs flush transmission of the conference data when a plurality of transfer buffers provided in the memory 122 stores one or more conference data addressed to the server apparatus S1 that have been received during the period (P201) until the first update request data is received (T203) and that are not yet transmitted by the transfer processing (T205). Specifically, the following processing is performed. The CPU 112 sequentially extracts, in a FIFO format, the particular data specified by the setting information 16 stored in the memory 122 from among one or more conference data stored in the plurality of transfer buffers, and transmits the extracted data to the server apparatus S1. The CPU 112 repeats the processing to transmit the particular data to the server apparatus S1 until there is no more conference data addressed to the server apparatus S1 stored in the plurality of transfer buffers. The CPU 111 of the server apparatus S1 receives the particular data transmitted from the server apparatus S2 (T207).

After the completion of the flush transmission, the CPU 112 of the server apparatus S2 changes and updates the management table 152 stored in the memory 122 in such a manner that the ID “S1” of the server apparatus S1 associated with the ID “C1” of the terminal apparatus C1 is changed to the ID “S2” of the server apparatus S2 (U209). Based on the updated management table 152, the CPU 112 resumes the processing to transfer the conference data. For example, when the CPU 112 receives the conference data addressed to the terminal apparatus C1, the CPU 112 transmits the received conference data to the terminal apparatus C1 and does not transfer the data to the server apparatus S1. The CPU 112 transmits, to the server apparatus S1, a first update completion notification data showing that the update of the management table 152 is completed (T209). The CPU 111 of the server apparatus S1 receives the first update completion notification data (T211).

The CPU 111 of the server apparatus S1 determines whether the communication system 1 includes therein the server apparatus S other than the server apparatus S1 that is the handling server apparatus of the terminal apparatus C1 prior to the switching and the server apparatus S2 that is the handling server apparatus of the terminal apparatus C1 after the switching (J001). In the embodiment, the CPU 111 determines that the communication system 1 includes therein the plurality of server apparatuses S (the server apparatuses S3 and S4) other than the server apparatuses S1 and S2.

The CPU 111 transmits, to the server apparatus S3, a second update request data to change the handling server apparatus of the terminal apparatus C1 specified in the management table 153 (see FIG. 1) stored in the memory 123 of the server apparatus S3 from the server apparatus S1 to the server apparatus S2 (T221). The CPU 111 transmits, to the server apparatus S4, the second update request data to change the handling server apparatus of the terminal apparatus C1 specified in the management table 154 (see FIG. 1) stored in the memory 124 of the server apparatus S4 from the server apparatus S1 to the server apparatus S2 (T221). Specifically, the CPU 111 transmits the second update request data to all server apparatuses S (the server apparatuses S3 and S4) other than the server apparatuses S1 and S2.

The CPU 113 of the server apparatus S3 receives the second update request data (T223). The CPU 113 performs flush transmission of the conference data when a plurality of transfer buffers provided in the memory 123 stores one or more conference data addressed to the server apparatus S1 that are received during the period (P203) until the second update request data is received (T223) and that are not yet transmitted by the transfer processing (T225). Specifically, the following processing is performed. The CPU 113 sequentially extracts, in a FIFO format, the particular data specified by the setting information 16 stored in the memory 123 from among one or more conference data stored in the plurality of transfer buffers, and transmits the extracted data to the server apparatus S1. The CPU 113 repeats the processing to transmit the conference data to the server apparatus S1 until there is no more conference data addressed to the server apparatus S1 stored in the plurality of transfer buffers. The CPU 111 of the server apparatus S1 receives the conference data transmitted from the server apparatus S3 (T227). The same processing as the one described above is also performed in the CPU 114 of the server apparatus S4 having received the second update request data.

After the completion of the flush transmission, the CPU 113 of the server apparatus S3 changes and updates the management table 153 stored in the memory 123 in such a manner that the ID “S1” of the server apparatus S1 associated with the ID “C1” of the terminal apparatus C1 is changed to the ID “S2” of the server apparatus S2 (U229). Based on the updated management table 153, the CPU 113 resumes the processing to transfer the conference data. For example, when the CPU 113 receives the conference data addressed to the terminal apparatus C1, the CPU 113 transfers the received conference data to the server apparatus S2 and does not transfer the data to the server apparatus S1. The CPU 113 transmits, to the server apparatus S1, the second update completion notification data showing that the update of the management table 153 is completed (T229). The same processing as the one described above is also performed in the CPU 114 of the server apparatus S4 having received the second update request data.

The CPU 111 of the server apparatus S1 receives the second update completion notification data (T231). The CPU 111 determines whether the CPU 111 has received the second update completion notification data from all of the server apparatuses S3 and S4 to which the second update request data has been transmitted in T221 (J003). When the CPU 111 determines that the CPU 111 does not receive the second update completion notification data from at least any one of the server apparatuses S3 and S4, the CPU 111 completes the communication sequence in the third phase after waiting for a particular period.

When the CPU 111 determines that the second update completion notification data is received from all of the server apparatuses S3 and S4, the CPU 111 executes the following processing. Here, the CPU 111 suspends the transfer processing during the period after the first update request data is transmitted to the server apparatus S1 in T201 and before the second update completion notification data is received in T231. Thus, when the conference data addressed to the terminal apparatus C1 is received during this period, the conference data is stored in the plurality of transfer buffers provided in the memory 121 (V201). The CPU 111 performs flush transmission of the conference data when the plurality of transfer buffers stores one or more conference data addressed to the server apparatus S1 (T233). Specifically, the following processing is performed. The CPU 111 sequentially extracts, in a FIFO format, the particular data specified by the setting information 16 stored in the memory 121 from among one or more conference data stored in the plurality of transfer buffers, and transmits the extracted data to the terminal apparatus C1. The CPU 112 repeats the processing to transmit the conference data to the terminal apparatus C1 until there is no more conference data addressed to the terminal apparatus C1 stored in the plurality of transfer buffers. The CPU 211 of the terminal apparatus C1 receives the conference data transmitted from the server apparatus S1 (T235). It is noted that, during the period from T121 (see FIG. 4) to T305 (see FIG. 6), the CPU 211 sequentially stores the received conference data in the plurality of transfer buffers but not sequentially extracts or processes the stored conference data (V301).

After the completion of the flush transmission, the CPU 111 of the server apparatus S1 changes and updates the management table 151 stored in the memory 121 in such a manner that the ID “S1” of the server apparatus S1 associated with the ID “C1” of the terminal apparatus C1 is changed to the ID “S2” of the server apparatus S2 (U233). Based on the updated management table 151, the CPU 111 resumes the processing to transfer the conference data. For example, when the CPU 111 receives the conference data addressed to the terminal apparatus C1, the CPU 111 transfers the received conference data to the server apparatus S2 and does not transfer the data to the terminal apparatus C1.

When the communication system 1 includes only the server apparatuses S1 and S2 for example, the CPU 111 determines, in the processing of J001, that the communication system 1 does not include therein the server apparatus S other than the server apparatuses S1 and S2. In this case, the CPU 111 does not perform T221, T227, T231, and J003. The CPU 111 performs the flush transmission as required (T233). Thereafter, the CPU 111 updates the management table 151 stored in the memory 121 (U233). Based on the updated management table 151, the CPU 111 resumes the processing to transfer the conference data.

<Fourth Phase>

With reference to FIG. 6, the following section will describe the communication sequence in the fourth phase. First, the CPUs 111 and 112 of the respective server apparatuses S1 and S2 perform synchronization processing to synchronize the setting information 16 stored in the memories 121 and 122, respectively (Y001).

The CPU 111 of the server apparatus S1 performs the synchronization processing as described below. The CPU 111 transmits, to the server apparatus S2, the setting information 16 and flag information stored in the memory 121. The CPU 111 receives the setting information 16 and flag information transmitted from the server apparatus S2. The CPU 111 refers to flag information associated with the received setting information 16 and to flag information associated with the setting information 16 stored in the memory 121, and executes any of the processing in (1) to (3) below.

(1) When both setting information 16 are associated with flag information “0” showing that the contents are not changed, the CPU 111 determines that the setting information 16 stored in the memory 121 can be used as it is.

(2) When one setting information 16 is associated with flag information “1” showing that the contents are changed, the CPU 111 uses the setting information 16 associated with the flag information “1” to update the setting information 16 stored in the memory 121. Specifically, when the received setting information 16 is associated with the flag information “1”, the CPU 111 updates the setting information 16 by storing the received setting information 16 in the memory 121. On the other hand, when the setting information 16 stored in the memory 121 is associated with the flag information “1”, the CPU 111 determines that this setting information 16 can be used as it is.

(3) When both flag information are associated with the flag information “1” showing that the contents are changed, the CPU 111 determines that the setting information 16 stored in the memory 121 can be used as it is.

The CPU 112 of the server apparatus S2 executes the synchronization processing as described below. The CPU 112 transmits, to the server apparatus S1, the setting information 16 and flag information stored in the memory 122. The CPU 112 receives the setting information 16 and flag information transmitted from the server apparatus S1. The CPU 112 refers to flag information associated with the received setting information 16 and to flag information associated with the setting information 16 stored in the memory 122, and executes the same processing as in (1) and (2) above or the processing in (4) below.

(4) When both flag information is associated with the flag information “1” showing that the contents are changed, the CPU 112 uses the setting information 16 received from the server apparatus S1 for conference data that are transmitted and received between the CPU 112 and the terminal apparatus C1 through the server apparatus S1. On the other hand, the CPU 112 uses the setting information 16 stored in the memory 122 for conference data transmitted and received between the CPU 112 and the terminal apparatus C1.

After the execution of the synchronization processing by Y001, the CPU 111 of the server apparatus S1 transmits, to the terminal apparatus C1, switching completion notification data notifying that the preparation to switch the handling server apparatus of the terminal apparatus C1 from the server apparatus S1 to the server apparatus S2 is completed (T301). The CPU 211 of the terminal apparatus C1 receives the switching completion notification data (T303). The CPU 211 transmits, to the server apparatus S1, switching completion response data in response to the switching completion notification data (T305). The CPU 111 of the server apparatus S1 receives the switching completion response data (T307).

After the switching completion response data is transmitted to the server apparatus S1 in T305, the CPU 211 of the terminal apparatus C1 changes the handling server ID stored in the memory 221 from the ID “S1” of the server apparatus S1 to the ID “S2” of the server apparatus S2 (U305).

The CPU 211 suspends the transmission processing during the period after the ACK is transmitted from the CPU 211 to the server apparatus S1 in T121 (see FIG. 4) and before the switching completion response data is transmitted to the server apparatus S1 in T305. Thus, when conference data is acquired through a camera and a microphone of the input interface 53 during this period, the conference data is stored in a plurality of transmission buffers provided in the memory 221 (V301). The CPU 211 performs flush transmission of the conference data when the plurality of transmission buffers stores one or more conference data (T309). Specifically, the following processing is performed. The CPU 211 sequentially, extracts in a FIFO format, one or more conference data stored in the plurality of transmission buffers, and transmits the extracted data to the server apparatus S2 having the handling server ID “S2” stored in the memory 221. The CPU 211 repeats the processing to transmit the conference data to the server apparatus S2 until there is no more conference data stored in the plurality of transmission buffers. The CPU 112 of the server apparatus S2 receives the conference data transmitted from the terminal apparatus C1 (T311).

The CPU 211 also suspends the reception processing during the period after the ACK is transmitted from the CPU 211 to the server apparatus S1 in T121 (see FIG. 4) before the switching completion response data is transmitted to the server apparatus S1 in T305. Thus, when particular data is received during this period, the particular data is stored in a plurality of reception buffers provided in the memory 221 (V301). When the plurality of reception buffers stores one or more particular data, the CPU 211 firstly extracts, from among the stored particular data, particular data transmitted from the server apparatus S1 as a handling server apparatus prior to the switching, and processes the data. After the CPU 211 processes all of the particular data transmitted from the server apparatus S1, the CPU 211 subsequently extracts, from among the particular data stored in the plurality of reception buffers, particular data transmitted from the server apparatus S2 and processes the data.

The CPU 211 of the terminal apparatus C1 transmits, to the server apparatus S1, a disconnection request to disconnect the connection with the server apparatus S1. The CPU 111 of the server apparatus S1 receives the disconnection request and disconnects the connection with the terminal apparatus C1 (T313, T315).

### Operation and Effects of the Embodiment

First, the server apparatus S1 changes the handling server apparatus of the terminal apparatus C1 in the management table 152 of the server apparatus S2 from the server apparatus S1 to the server apparatus S2 (T201). Next, the server apparatus S1 changes the handling server apparatus of the terminal apparatus C1 in the management tables 153 and 154 of the server apparatuses S3 and S4 from the server apparatus S1 to the server apparatus S2 (T221). Thereafter, the server apparatus S1 changes the handling server apparatus of the terminal apparatus C1 in the management table 151 of the server apparatus S1 from the server apparatus S1 to the server apparatus S2 (U233). That is, after the update of all of the management tables 152, 153, and 154 of other server apparatuses S2, S3, and S4 is completed, the management table 151 of the server apparatus S1 is updated. As a result, during the switching of the management table 15, the communication system 1 can suppress particular data from being transmitted from a plurality of server apparatuses S to the terminal apparatus C. Thus, for example, the sequence of a plurality of particular data received in the terminal apparatus C is maintained even if a plurality of data transmitted and received from the terminal apparatuses C is not attached with information showing the sequence of data. Furthermore, even when a plurality of data transmitted and received between the terminal apparatuses C is attached with information showing the sequence of data, there is a possibility that the sequence of the transmission cannot be maintained when the data is thinned (that is, partially omitted). However, even in such a case, the server apparatus S1 in the embodiment maintains the sequence of a plurality of particular data received in the terminal apparatus C.

In the communication system 1, the server apparatuses S store the management tables 15 in the memories 12, respectively. Thus, for example, each server apparatus S need not transmit a query to the main server apparatus, or the main server need not be stopped during the update of the management table 15 such as when only a specific main server apparatus stores the management table 15 therein. Thus, the server apparatus S easily performs processing to switch the handling server apparatus of the terminal apparatus C to another server apparatus.

The server apparatus S1 switches the handling server apparatus of the terminal apparatus C1 in the management table 151 from the server apparatus S1 to the server apparatus S2 and subsequently disconnects the connection with the terminal apparatus C1 (T313, T315). In this case, the server apparatus S1 reliably switches the handling server apparatus of the terminal apparatus C1 from the server apparatus S1 to the server apparatus S2.

When the server apparatus S1 determines that the communication system 1 includes a plurality of server apparatuses S3 and S4 other than the server apparatuses S1 and S2 (J001), the server apparatus S1 transmits the second update request data to the server apparatuses S3 and S4 (T221). In response to determining that the second update completion notification data is received from all of the server apparatuses S3 and S4 (J003), the server apparatus S1 updates the management table 151 (U233). In this case, the server apparatus S1 updates the management table 151 after the management tables 153 and 154 are updated in all of the server apparatuses S3 and S4 other than the server apparatuses S1 and S2. Thus, the server apparatus S1 reliably maintains the sequence of a plurality of data received by the terminal apparatus C during the switching of the handling server apparatus.

During the period after the first update request data is transmitted from the server apparatus S1 (T201) and before the second update completion notification data is received (T231), the management tables 152 to 154 of the server apparatuses S2 to S4 are updated. Thus, there is a possibility that conference data is transmitted from the server apparatus S2 to the terminal apparatus C1 during this period. When conference data is further transmitted from the server apparatus S1 to the terminal apparatus C1, the sequence of conference data received by the terminal apparatus C1 may be changed. To prevent this, the server apparatus S1 suspends the transfer processing that is executed in parallel with the communication sequence performed in the period from T201 to T231 (V201). During this period, when the server apparatus S1 receives conference data addressed to the terminal apparatus C1, the server apparatus S1 sequentially stores the conference data in a plurality of transfer buffers provided in the memory 121. On the other hand, the server apparatus S1 does not sequentially extract the conference data stored in the plurality of transfer buffers and does not transmit the data to the terminal apparatus C1 (V201). When, after T231, a plurality of transfer buffers provided in the memory 122 stores one or more conference data addressed to the terminal apparatus C1, the CPU 111 performs flush transmission of the conference data (T233). As a result, the server apparatus S1 reliably maintains the sequence of conference data received in the terminal apparatus C1.

In the transfer processing executed by the server apparatus S, particular data specified by the setting information 16 is extracted from the conference data and is transmitted. After the management tables 151 and 152 are updated, the server apparatuses S1 and S2 execute the synchronization processing to synchronize the setting information 16 (Y001). After the setting information 16 is synchronized with the server apparatus S2, the server apparatus S1 disconnects the link connection with the terminal apparatus C1. Thus, after the particular data is transferred to the terminal apparatus C1 based on the setting information 16 common in the server apparatuses S1 and S2, the server apparatus S1 disconnects the link connection to thereby reliably change the handling server apparatus to the server apparatus S2. The setting information 16 specifies at least whether audio data is necessary. In this case, when audio data for example is unnecessary, the server apparatus S excludes the audio data from the setting information 16 to thereby streamline conference data transmitted and received among the terminal apparatuses C to suppress a situation where unnecessary conference data causes large traffic in the network N.

The server apparatus S1 transmits, to the terminal apparatus C1, preparation request data to switch the handling server apparatus of the terminal apparatus C1 (T117). After the link connection with the server apparatus S2 is established, the terminal apparatus C1 transmits the ACK to the server apparatus S1 (T121). Upon receiving the ACK transmitted from the terminal apparatus C1 (T123), the server apparatus S1 transmits the first update request data to the server apparatus S2 (T201). In this case, the server apparatus S1 appropriately determines that the link connection is established between the server apparatus S2 and the terminal apparatus C1, and transmits the first update request data to the server apparatus S2 to update the management table 152.

When the communication system 1 includes only the server apparatuses S1 and S2, the server apparatus S1 does not execute T221, T227, T231, and J003 because the communication system 1 does not include the server apparatus S other than the server apparatuses S1 and S2 (J001), and the server apparatus S1 updates the management table 151 (U233). In this case, the server apparatus S1 quickly updates its management table 151 after the management table 152 of the server apparatus S2 is updated.

During the period after the first update request data is transmitted from the server apparatus S1 (T201) and before the second update completion notification data is received (T231), the management tables 152 to 154 of the server apparatuses S2 to S4 are updated. During this period, the update state of the management table 15 is unstable. Thus, it is preferable for the terminal apparatus C1 not to transmit conference data during this period. To achieve this, during the period after the ACK is transmitted to the server apparatus S1 in T121 and before the switching completion response data is transmitted to the server apparatus S1 in T305, the terminal apparatus C1 suspends the transmission processing (V301). After T305, the terminal apparatus C1 performs flush transmission of the conference data stored in a plurality of transmission buffers to the server apparatus S2 (T309). This consequently allows the terminal apparatus C1 to suppress the transmission of the conference data during the switching of the management table 15 in the server apparatus S and to resume, after the completion of the switching of the management table 15, the transmission of conference data to the server apparatus S2 as a new handling server apparatus. In this case, the sequence of the conference data transmitted from the terminal apparatus C1 is reliably maintained when the conference data is received by other terminal apparatuses C2 to C4.

<Modifications>

While the disclosure has been described in detail with reference to the above aspects thereof, it would be apparent to those skilled in the art that various changes and modifications may be made therein without departing from the scope of the claims.

For example, in the second phase, in response to receiving, from the master server apparatus MS, the switching instruction data to switch the handling server apparatus of the terminal apparatus C1 from the server apparatus S1 to the server apparatus S2 (T103), the CPU 111 of the server apparatus S1 transmits connection request data to the terminal apparatus C1 (T105). In contrast, the CPU 111 may transmit the connection request data to the server apparatus S2 in response to detecting an increase in its own processing load. In this case, permission/denial request data in the first phase may also be transmitted from the server apparatus S1 to the server apparatus S2. In this case, the communication system 1 may not include therein the master server apparatus MS.

After the CPU 211 of the terminal apparatus C1 changes the handling server ID stored in the memory 221 from “S1” to “S2” (U305), the CPU 211 transmits, to the server apparatus S1, a disconnection request to disconnect the connection with the server apparatus S1. The CPU 111 of the server apparatus S1 receives the disconnection request and disconnects the connection with the terminal apparatus C1 (T313, T315). In contrast, the CPU 211 of the terminal apparatus C1 itself may disconnect the connection with the server apparatus S1 after the handling server ID is updated. In this case, the CPU 211 may not transmit the disconnection request to the server apparatus S1.

When the second update request data is transmitted to all of the server apparatuses S3 and S4 other than the server apparatuses S1 and S2 (T221), the CPU 111 of the server apparatus S1 may simultaneously transmit a plurality of the second update request data by multicast communication. On the other hand, the CPU 111 may firstly transmit the second update request data to the server apparatus S3 and, after receiving the second update completion notification (T231), next transmit the second update request data to the server apparatus S4.

During the period after the first update request data is transmitted (T201) and before the second update completion notification data is received (T231), the CPU 111 of the server apparatus S1 suspends the transfer processing executed in parallel with the communication sequence (V201). Conference data addressed to the terminal apparatus C1 received during this period is sequentially stored in a plurality of transfer buffers and is not transmitted to the terminal apparatus C1 (V201). In contrast, the CPU 111 may discard the conference data addressed to the terminal apparatus C1 received during the period from T201 to T231 and transmit a NACK (Negative ACKnowledge) to the transmission source to request retransmission. After T231, when the CPU 111 receives the retransmitted conference data, the CPU 111 may transfer the data to the terminal apparatus C1.

After the update of the management tables 151 and 152, the server apparatuses S1 and S2 execute the synchronization processing in order to synchronize the setting information 16 at the start of the fourth phase (Y001). However, the timing at which the synchronization processing is executed is not limited to the start of the fourth phase. For example, the synchronization processing may be executed at any time in the first phase to the third phase. The setting information 16 may not be stored in the memory 12. The CPU 11 of the server apparatus S may execute the transfer processing for all of the received conference data. In this case, the synchronization processing may not be executed.

Data specified by the setting information 16 is not limited to that of the above embodiment. For example, the setting information may be such data that specifies only whether video data is necessary or whether audio data is necessary or such data that specifies only whether audio data is necessary. The setting information 16 also may specify various types of information for the setting of teleconference (e.g., video resolution and compression ratio, or audio compression ratio).

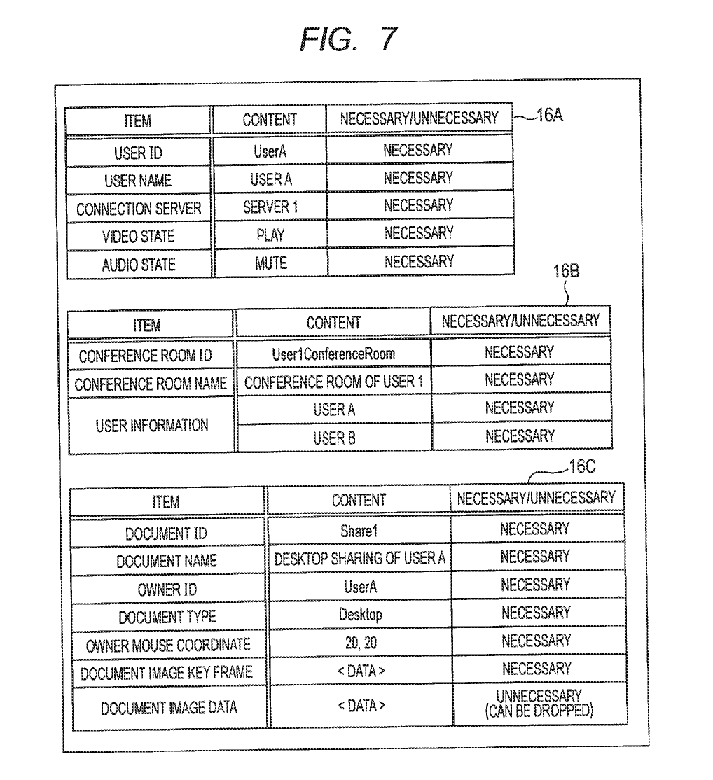

For example, as in the setting information 16A shown in FIG. 7, the setting information may also include user information regarding each terminal apparatus C or a user using each terminal apparatus C. For example, as in the setting information 16B, the setting information may include conference room information specified for each conference room. For example, as in the setting information 16C, the setting information may include document information specified for each document. The setting information 16A to 16C may be stored in the master server apparatus MS or may be stored in a handling server apparatus that handles the terminal apparatus C used by the user. When the master server MS stores the setting information, the synchronization processing executed in Y001 (see FIG. 6) may be executed by the CPU of the master server apparatus MS and the respective CPUs 111 and 112 of the server apparatuses S1 and S2.

When the CPU 111 of the server apparatus S1 receives the ACK (T123) in response to the preparation request data (T117) transmitted to the terminal apparatus C1, the CPU 111 transmits the first update request data to the server apparatus S2 (T201). In contrast, the CPU 111 may transmit the first update request data to the server apparatus S2 in response to the reception (T115) of the connection completion notification data (T113) from the terminal apparatus C1 transmitted in response to the establishment of the link connection between the terminal apparatus C1 and the server apparatus S2.

The CPU 211 of the terminal apparatus C1 suspends the transmission processing (V301) during the period after the ACK is transmitted to the server apparatus S1 in T121 and before the switching completion notification data is transmitted to the server apparatus S1 in T305. In contrast, the CPU 211 may continue to transmit the conference data to the server apparatus S1 during the period from T121 to T305.

What is claimed is:

1. A non-transitory computer-readable storage medium storing a communication program executable on a computer of a first server apparatus in a plurality of server apparatuses configured to control communication among a plurality of terminal apparatuses, each of the plurality of server apparatuses having a memory storing a management table specifying a handling server apparatus configured to perform communication with the plurality of terminal apparatuses, each of the plurality of server apparatuses being configured to identify a terminal apparatus to perform communication with based on the management table and to transfer data to the identified terminal apparatus, the communication program causing, when executed, the first server apparatus to perform operations comprising:
transmitting, to a first terminal apparatus, a connection request for requesting connection between the first terminal apparatus and a second server apparatus different from the first server apparatus;
after the first terminal apparatus and the second server apparatus are connected based on the connection request, receiving a connection completion notification transmitted from the first terminal apparatus;
in response to receiving the connection completion notification, transmitting a first update request to the second server apparatus, the first update request being for updating the handling server apparatus of the first terminal apparatus specified in a second management table from the first server apparatus to the second server apparatus, the second management table being stored in a second memory of the second server apparatus;
after the second management table is updated based on the first update request, receiving a first update completion notification transmitted from the second server apparatus;
in response to receiving the first update completion notification, transmitting a second update request to a third server apparatus, the second update request being for updating the handling server apparatus of the first terminal apparatus specified in a third management table from the first server apparatus to the second server apparatus, the third management table being stored in a third memory of a third server apparatus different from the first server apparatus and the second server apparatus;
after the third management table is updated based on the second update request, receiving a second update completion notification transmitted from the third server apparatus; and
in response to receiving the second update completion notification, updating the handling server apparatus of the first terminal apparatus specified in a first management table from the first server apparatus to the second server apparatus, the first management table being stored in a first memory of the first server apparatus, thereby changing the handling server apparatus of the first terminal apparatus from the first server apparatus to the second server apparatus.

2. The non-transitory computer-readable storage medium according to claim 1, wherein the communication program further causes, when executed, the first server apparatus to perform operations further comprising:
after the first management table is updated, disconnecting connection with the first terminal apparatus.

3. The non-transitory computer-readable storage medium according to claim 1, wherein the communication program further causes, when executed, the first server apparatus to perform operations further comprising:
in a case where the third server apparatus includes a plurality of third server apparatuses, transmitting the second update request to all of the plurality of third server apparatuses;
determining whether the second update completion notification is received from all of the plurality of third server apparatuses; and
in response to determining that the second update completion notification is received from all of the plurality of third server apparatuses, updating the first management table.

4. The non-transitory computer-readable storage medium according to claim 1, wherein the communication program further causes, when executed, the first server apparatus to perform operations further comprising:
in response to receiving data addressed to the first terminal apparatus during a period after the first update request is transmitted and before the second update completion notification is received, retaining the data; and
transmitting the retained data to the first terminal apparatus in a received sequence, during a period after the second update completion notification is received and before the first management table is updated.

5. The non-transitory computer-readable storage medium according to claim 2, wherein each of the plurality of server apparatuses is configured to further store, in the memory, setting information relating to data transmitted and received among the plurality of terminal apparatuses, and is configured to transfer particular data, among the transmitted and received data, identified based on the setting information; and
wherein the communication program further causes, when executed, the first server apparatus to perform operations further comprising:
after the first management table is updated, synchronizing the setting information with the second server apparatus; and
after the setting information is synchronized, disconnecting connection with the first terminal apparatus.

6. The non-transitory computer-readable storage medium according to claim 5, wherein the setting information at least specifies whether audio data is necessary.

7. The non-transitory computer-readable storage medium according to claim 1, wherein the communication program further causes, when executed, the first server apparatus to perform operations further comprising:
after the connection completion notification is received, transmitting, to the first terminal apparatus, a preparation request for requesting preparation for switching the handling server apparatus; and
in response to receiving an ACK transmitted from the first terminal apparatus based on the preparation request, transmitting the first update request to the second server apparatus.

8. The non-transitory computer-readable storage medium according to claim 1, wherein the communication program further causes, when executed, the first server apparatus to perform operations further comprising:
in response to receiving the first update completion notification, determining whether the third server apparatus exists;
in response to determining that the third server apparatus does not exist, updating the handling server apparatus of the first terminal apparatus specified in the first management table from the first server apparatus to the second server apparatus; and
in response to determining that the third server apparatus exists, transmitting the second update request to the third server apparatus.

9. The non-transitory computer-readable storage medium according to claim 7, wherein the communication program further causes, when executed, the first terminal apparatus to perform operations comprising:
in response to receiving the preparation request transmitted from the first server apparatus, transmitting the ACK to the first server apparatus;
after the ACK is transmitted, in response to receiving a switching completion notification transmitted after the first management table is updated, transmitting a switching completion response to the first server apparatus;
during a period after the ACK is transmitted and before the switching completion response is transmitted, retaining data addressed to the first server apparatus; and
after the switching completion response is transmitted, transmitting the retained data to the second server apparatus.

10. A communication method performed by a plurality of server apparatuses configured to control communication among a plurality of terminal apparatuses, each of the plurality of server apparatuses having a memory storing a management table specifying a handling server apparatus configured to perform communication with the plurality of terminal apparatuses, each of the plurality of server apparatuses being configured to identify a terminal apparatus to perform communication with based on the management table and to transfer data to the identified terminal apparatus, the method comprising:
transmitting, from a first server apparatus to a first terminal apparatus, a connection request for requesting connection between the first terminal apparatus and a second server apparatus different from the first server apparatus;
after the first terminal apparatus and the second server apparatus are connected based on the connection request, receiving, by the first server apparatus, a connection completion notification transmitted from the first terminal apparatus;
in response to receiving the connection completion notification, transmitting a first update request from the first server apparatus to the second server apparatus, the first update request being for updating the handling server apparatus of the first terminal apparatus specified in a second management table from the first server apparatus to the second server apparatus, the second management table being stored in a second memory of the second server apparatus;
after the second management table is updated based on the first update request, receiving, by the first server apparatus, a first update completion notification transmitted from the second server apparatus;
in response to receiving the first update completion notification, transmitting a second update request from the first server apparatus to a third server apparatus, the second update request being for updating the handling server apparatus of the first terminal apparatus specified in a third management table from the first server apparatus to the second server apparatus, the third management table being stored in a third memory of a third server apparatus different from the first server apparatus and the second server apparatus;
after the third management table is updated based on the second update request, receiving, by the first server apparatus, a second update completion notification transmitted from the third server apparatus; and
in response to receiving the second update completion notification, updating the handling server apparatus of the first terminal apparatus specified in a first management table from the first server apparatus to the second server apparatus, the first management table being stored in a first memory of the first server apparatus, thereby changing the handling server apparatus of the first terminal apparatus from the first server apparatus to the second server apparatus.

11. The communication method according to claim 10, further comprising:
after the first management table is updated, disconnecting connection between the first server apparatus and the first terminal apparatus.

12. The communication method according to claim 10, further comprising:
after the connection completion notification is received, transmitting, from the first server apparatus to the first terminal apparatus, a preparation request for requesting preparation for switching the handling server apparatus; and
in response to receiving, by the first server apparatus, an ACK transmitted from the first terminal apparatus based on the preparation request, transmitting the first update request from the first server apparatus to the second server apparatus.

13. The communication method performed in each of the plurality of terminal apparatuses according to claim 12, comprising:
in response to receiving the preparation request transmitted from the first server apparatus, transmitting the ACK from the first terminal apparatus to the first server apparatus;
after the ACK is transmitted, in response to receiving a switching completion notification transmitted after the first management table is updated, transmitting a switching completion response from the first terminal apparatus to the first server apparatus;
during a period after the ACK is transmitted and before the switching completion response is transmitted, retaining, by the first terminal apparatus, data addressed to the first server apparatus; and
after the switching completion response is transmitted, transmitting the retained data from the first terminal apparatus to the second server apparatus.

14. A communication system comprising:
a plurality of terminal apparatuses; and
a plurality of server apparatuses configured to control communication among the plurality of terminal apparatuses, each of the plurality of server apparatuses having a memory storing a management table specifying a handling server apparatus configured to perform communication with the plurality of terminal apparatuses, each of the plurality of server apparatuses being configured to identify a terminal apparatus to perform communication with based on the management table and to transfer data to the identified terminal apparatus,
a first server apparatus of the plurality of server apparatuses comprising:
a controller; and
a first memory storing instructions, the instructions, when executed by the controller, causing the first server apparatus to perform:
transmitting, to a first terminal apparatus, a connection request for requesting connection between the first terminal apparatus and a second server apparatus different from the first server apparatus;
after the first terminal apparatus and the second server apparatus are connected based on the connection request, receiving a connection completion notification transmitted from the first terminal apparatus;
in response to receiving the connection completion notification, transmitting a first update request to the second server apparatus, the first update request being for updating the handling server apparatus of the first terminal apparatus specified in a second management table from the first server apparatus to the second server apparatus, the second management table being stored in a second memory of the second server apparatus;
after the second management table is updated based on the first update request, receiving a first update completion notification transmitted from the second server apparatus;
in response to receiving the first update completion notification, transmitting a second update request to a third server apparatus, the second update request being for updating the handling server apparatus of the first terminal apparatus specified in a third management table from the first server apparatus to the second server apparatus, the third management table being stored in a third memory of a third server apparatus different from the first server apparatus and the second server apparatus;
after the third management table is updated based on the second update request, receiving a second update completion notification transmitted from the third server apparatus; and
in response to receiving the second update completion notification, updating the handling server apparatus of the first terminal apparatus specified in a first management table from the first server apparatus to the second server apparatus, the first management table being stored in the first memory of the first server apparatus, thereby changing the handling server apparatus of the first terminal apparatus from the first server apparatus to the second server apparatus,
the first terminal apparatus comprising:
a terminal controller; and
a terminal memory storing instructions, the instructions, when executed by the controller, causing the first terminal apparatus to perform:
in response to receiving the connection request transmitted from the first server apparatus, connecting with the second server apparatus; and
after connecting with the second server apparatus, transmitting the connection completion notification to the first server apparatus.

15. The communication system according to claim 14, wherein the first memory further stores instructions, the instructions, when executed by the controller, causing the first server apparatus to perform:
after the connection completion notification is received, transmitting, to the first terminal apparatus, a preparation request for requesting preparation for switching the handling server apparatus;
after updating the first management table, transmitting a switching completion notification to the first terminal apparatus; and
in response to receiving an ACK transmitted from the first terminal apparatus based on the preparation request, transmitting the first update request to the second server apparatus; and
wherein the terminal memory further stores instructions, the instructions, when executed by the controller, causing the first terminal apparatus to perform:
in response to receiving the preparation request transmitted from the first server apparatus, transmitting the ACK to the first server apparatus;
after the ACK is transmitted, in response to receiving the switching completion notification, transmitting a switching completion response to the first server apparatus;
during a period after the ACK is transmitted and before the switching completion response is transmitted, retaining data addressed to the first server apparatus; and
after the switching completion response is transmitted, transmitting the retained data to the second server apparatus.
